(19) United States
(12) Patent Application Publication
(10) Pub. No.: US 2025/0274181 A1
(43) Pub. Date: Aug. 28, 2025

(54) CSI REPORTING FOR SUBSET OF CSI-RS RESOURCES

(71) Applicants: Viktor Sergeev, Lucan (IE); Kilian Peter Anton Roth, München (DE); Debdeep Chatterjee, San Jose, CA (US); Bishwarup Mondal, San Ramon, CA (US); Gang Xiong, Beaverton, OR (US); Sergey Panteleev, Maynooth (IE)

(72) Inventors: Viktor Sergeev, Lucan (IE); Kilian Peter Anton Roth, München (DE); Debdeep Chatterjee, San Jose, CA (US); Bishwarup Mondal, San Ramon, CA (US); Gang Xiong, Beaverton, OR (US); Sergey Panteleev, Maynooth (IE)

(21) Appl. No.: 19/203,475

(22) Filed: May 9, 2025

Related U.S. Application Data
(60) Provisional application No. 63/644,995, filed on May 9, 2024.
(60) Provisional application No. 63/645,029, filed on May 9, 2024.

(51) Int. Cl. H04B 7/06; H04W 24/10

(52) U.S. Cl. CPC H04B 7/0626; H04B 7/0639; H04W 24/10

(57) ABSTRACT

Systems and methods are disclosed for enabling channel state information (CSI) processing and reporting. A user equipment (UE) receives a CSI reporting configuration and measurements on CSI Reference Signal (CSI-RS) resources from a configured set, where some resources may be unavailable due to collisions or timing constraints. The UE measures CSI-RS on available resources from a subset, calculates and reports CSI based on the CSI-RS, with CSI-RS ports across resources used jointly for determining various values. When another subset is cancelled or dropped, the CSI is processed using zero channel power assumptions or adaptive precoding matrix calculations based on available resources. The UE calculates CSI performance metrics based on channel measurements and configuration parameters received from the network. The metrics quantify aspects, used by the UE to select appropriate CSI reporting configurations. The UE reports the metrics to the network or uses the metrics to adapt CSI content.

### PRIORITY CLAIM

This application claims the benefit of priority to U.S. Provisional Patent Application Ser. No. 63/644,995, filed May 9, 2024, 63/645,029, filed May 9, 2024, each of which is incorporated herein by reference in its entirety.

### TECHNICAL FIELD

Embodiments pertain to wireless networks and wireless communications. Some embodiments relate to Channel State Information (CSI) feedback in cellular networks using CSI Reference Signal (CSI-RS) resources.

### BACKGROUND

Mobile communication has evolved significantly from early voice systems to highly sophisticated integrated communication platform. Next-generation (NG) wireless communication systems, including 5th generation (5G) and sixth generation (6G) or new radio (NR) systems, are to provide access to information and sharing of data by various user equipment (UEs) and applications. NR is to be a unified network/system that is to meet vastly different and sometimes conflicting performance dimensions and services driven by different services and applications. As such, the complexity of such communication systems, as well as interactions between elements within a communication system, has increased. In particular, a number of applications demand devices with extremely limited size and power consumption that are unable to be met by current devices using protocols and mechanisms that can accommodate such constraints while maintaining reliable connectivity for massive numbers of devices operating in confined spaces.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a time-frequency view of a CSI-RS resource distribution, according to some examples.

FIG. 4 illustrates a transmission of second CSI-RS resource, according to some examples.

FIG. 5 illustrates a schematic diagram showing a functional view of a CSI reporting configuration selection system, according to some examples.

FIG. 6 illustrates a block diagram showing a CSI performance metrics calculation process at the UE, according to some examples.

FIG. 7 illustrates a block diagram illustrating the structure of a CSI report that includes both CSI data and CSI performance metrics, according to some examples.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

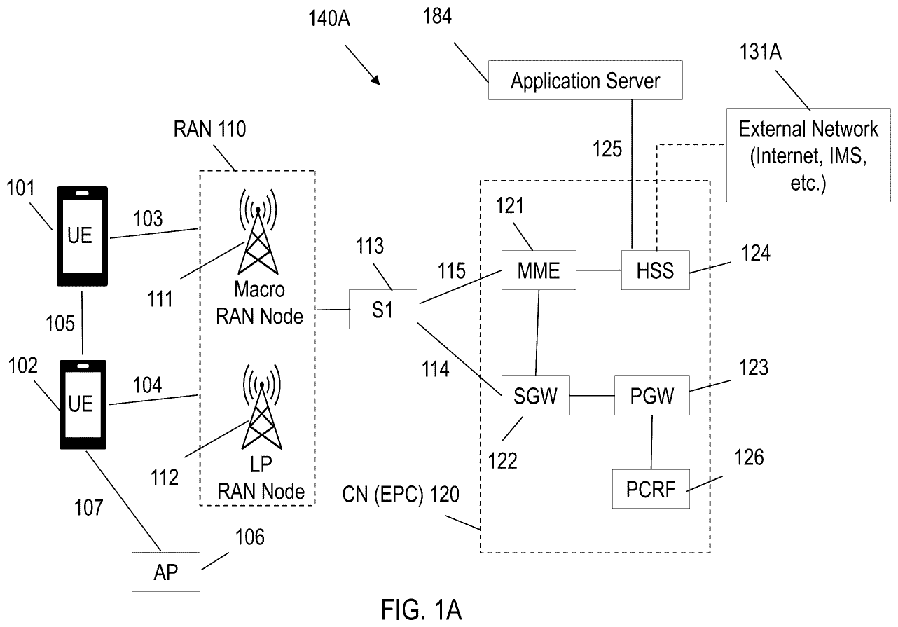

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPL MN) associated with a UE's Internet Protocol Connectivity Access Network (IP-CAN) session. In a roaming scenario with a local breakout of traffic, there may be two PCR Fs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SM Fs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NRV2X communication systems.

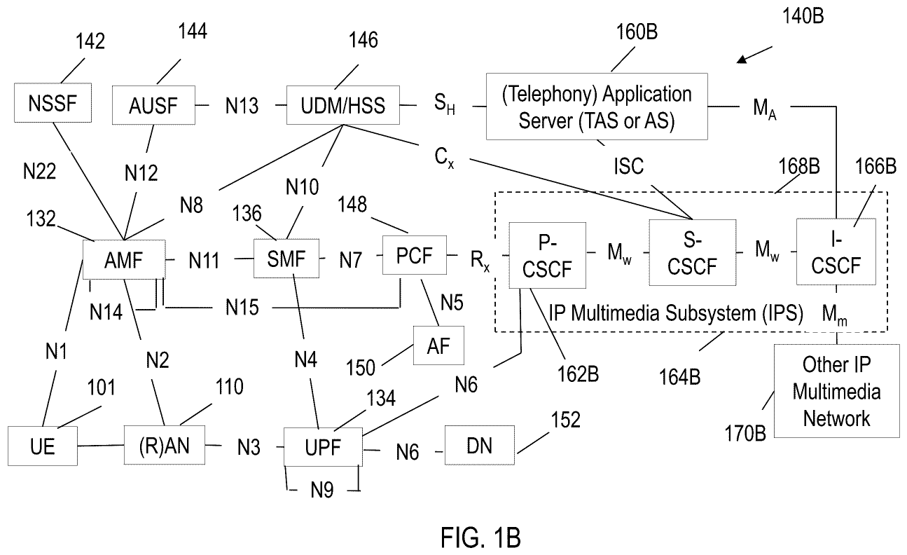

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured A SIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA 2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MULTEfire, UMTS Terrestrial Radio Access (UTRA), Evolved UM TS Terrestrial Radio Access (E-UTRA), Long Term Evolution Advanced (4th Generation) (LTE Advanced (4G)), cdmaOne (2G), Code division multiple access 2000 (Third generation) (CDMA 2000 (3G)), Evolution-Data Optimized or Evolution-Data Only (EV-DO), Advanced Mobile Phone System (1st Generation) (AM PS (1G)), Total Access Communication System/Extended Total Access Communication System (TACS/ETACS), Digital AM PS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for A utoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (M GWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, wireless communication networks rely on accurate CSI for optimizing downlink transmissions in cellular systems. Modern cellular networks use CSI-RS and CSI feedback mechanisms between UEs and gNBs to enable efficient data transmission. In NR systems, gNBs employ antenna arrays with multiple ports for digital beamforming and spatial multiplexing of data streams. The CSI feedback includes parameters including Channel Quality Indicator (CQI), Rank Indicator (RI), and Precoding Matrix Indicator (PMI) that are calculated based on channel measurements at the UE. Antenna ports in 5G may be logical entities (i.e., virtual antenna ports) at the physical layer (L1) used to represent a specific radio channel or transmission path (signaling and channel estimation). The antenna ports are distinguished by associated reference signal sequences and are not directly tied to individual physical antennas or RF connectors. Multiple logical antenna ports can be mapped to a single physical antenna, or a single logical port can be spread across multiple physical antennas, especially in beamforming scenarios.

The evolution of active antenna array technology has enabled the development of base station antenna arrays that support an increasing number of antenna ports for transmission and reception. Commercial base station implementations now commonly utilize arrays with 64 or more antenna ports for transmission and reception. However, current 5G NR physical layer specifications are designed for smaller antenna configurations, with optimized CSI-RS configurations and PMI codebooks limited to systems with 32 or fewer antenna ports.

To accommodate larger antenna configurations of up to 128 ports, the system processes multiple CSI-RS resources jointly, with each resource supporting up to 32 CSI-RS ports. These CSI-RS resources can be transmitted across different time slots. However, in TDD systems, certain CSI-RS resources may become unavailable due to various factors, such as collisions with other signals or channels, or during uplink/downlink switching periods.

Accordingly, methods are introduced for handling scenarios in which only a subset of configured CSI-RS resources is available for joint CSI processing at the UE. When CSI-RS resources are configured for channel measurement, the UE processes the available resources from set A1, which represents valid CSI-RS resources, while accounting for cancelled or dropped resources in set A2.

To manage CSI reporting with partial resource availability, in one example, the UE may calculate CSI assuming zero channel power for CSI-RS ports corresponding to cancelled or dropped resources, while maintaining the PMI codebook configuration for the total number of ports in the complete resource set. Alternatively, CSI may be calculated only for the available CSI-RS ports, and the PMI codebook may be adjusted to match the number of ports in the valid resource subset.

The temporal aspects of CSI processing are also addressed. When time restrictions for channel measurements are not configured, the UE can perform channel averaging using only the valid CSI-RS resources, excluding cancelled or dropped resources from the averaging calculations.

To enhance system flexibility, adaptive CSI reporting may be based on CSI performance metrics. The metrics can be calculated at the UE to evaluate various aspects of CSI quality, including compression loss, aging loss, averaging loss, and prediction loss. The metrics may help determine optimal CSI configurations and guide decisions about CSI content.

Compression loss measures how much CSI information is lost when compressing the channel information using PMI codebooks. This can be evaluated for immediate channel measurements, averaged measurements, or predicted measurements. The loss compares the difference between the compressed precoding matrix (using codebook) and the uncompressed precoding matrix.

A ging loss quantifies how much the channel state information degrades over time by comparing CSI measurements taken at different time instances. This is particularly relevant for high-speed scenarios where channel conditions change rapidly. The aging loss can be measured using either compressed or uncompressed precoding matrices, or a combination of both.

A veraging loss evaluates the accuracy impact of using averaged channel measurements compared to instantaneous measurements. This loss metric helps determine whether channel averaging improves or degrades CSI accuracy under specific conditions. The comparison can be made using compressed precoding matrices, uncompressed matrices, or both.

Prediction loss measures the accuracy of CSI prediction by comparing predicted channel information against actual measurements. This loss can be evaluated relative to aging loss or averaging loss to determine if prediction provides better performance than using aged or averaged measurements. The metric is particularly useful for adapting prediction horizons based on UE mobility, with different configurations for low-speed (20 ms prediction) and high-speed (10 ms prediction) scenarios.

These loss metrics can be calculated using different mathematical approaches including normalized mean square error, generalized cosine similarity, and square generalized cosine similarity. The metrics help determine optimal CSI configurations and guide decisions about CSI content.

PMI codebook selection and parameter adaptation based on CSI performance metrics are also presented. In particular, UEs can select between different PMI codebook types or adjust codebook parameters based on measured compression loss or prediction performance. The system may also configure different PMI codebooks depending on channel conditions, such as UE movement speed or the presence of line-of-sight conditions.

For CSI prediction scenarios, the prediction parameters may be adapted based on channel conditions. The UE can decide whether to apply CSI prediction and indicate the choice in the CSI report. Similar adaptations can be made for CSI averaging, with the UE signaling whether averaging was performed.

The CSI performance metrics may be reported to the network. The metrics can be transmitted either separately or jointly with CSI reports, allowing the network to optimize CSI configurations. Additionally, the system supports reporting simplified performance monitoring outputs, such as comparison results between metrics and configured thresholds.

Resource transmission in available slots may be used to manage CSI-RS resource timing. When CSI-RS resources cannot be transmitted in their originally scheduled slots due to conflicts with uplink periods or other signals, the system can delay transmission to the next available slot. This ensures reliable CSI measurement while maintaining system flexibility.

In more detail, CSI feedback is used in 5G NR systems to assist scheduling, link adaptation, precoding and spatial multiplexing operations for downlink (DL) transmission, such as the physical downlink shared channel (PDSCH). The CSI report is transmitted from the UE to the gNB via the physical uplink control channel (PUCCH) or physical uplink shared channel (PUSCH) in Uplink Control Information (UCI).

The CSI report includes: CRI, which indicates the CSI-RS resource selected by the UE and used for computation of other CSI components in the CSI report; RI, which contains information on the number of spatial layers (rank) recommended by the UE for the PDSCH; PMI, which contains information on the precoding matrix recommended by the UE for PDSCH; and CQI, which contains information on the modulation and coding scheme (MCS) recommended by the UE for the PDSCH.

For a given CSI report, the UE is configured with K≥1 CSI-RS resources each corresponding to P≥1 CSI-RS ports. To determine the CRI/RI/PMI/CQI for the CSI report, the UE measures channel on the configured CSI-RS resources/ports.

For the PMI codebooks supported for NR, except PMI codebook for Coherent Joint Transmission (CJT), P∈{2,4,8,12,16,24,32} for K=1, P∈{2,4,8,12,16} for K=2, P∈{2,4,8} for 2<K≤8 can be configured. A UE selects one CSI-RS resource and determines the RI, PMI, and CQI by using a channel measurement on the selected CSI-RS resource. An index of the selected CSI-RS resource corresponds to the reported CRI.

For the PMI codebook for CJT, P∈{4,8,12,16,24,32} for K∈{1,2,3,4}. A UE reports the RI, PMI and CQI by using the channel measured on all the configured CSI-RS resources.

### CSI-RS Reception

In Release 19 of the 5G NR specification, CSI reporting with the PMI codebook for up to 128 CSI-RS ports is supported. In this case, the K CSI-RS resources are jointly used for RI/PMI/CQI computation for a CSI report. The K CSI-RS resources may be transmitted in multiple slots.

As above, the TDD system has unique issues as CSI-RS reception in UL slots is not possible. In this case, the UE receives only subset of the CSI-RS resources. CSI-RS dropping may occur due to collision with other signals/channels (e.g., Synchronization Signals Block (SSB)) or semi-statically configured UL symbols in the case of TDD symbols. The set of the CSI-RS resources configured for joint RI/PMI/CQI processing is denoted as A, the subset of CSI-RS resources that are transmitted (or valid CSI-RS resources) is denoted as A_{1ϵ}A, the subset of cancelled or dropped CSI-RS resources is denoted as A_{2ϵ}A.

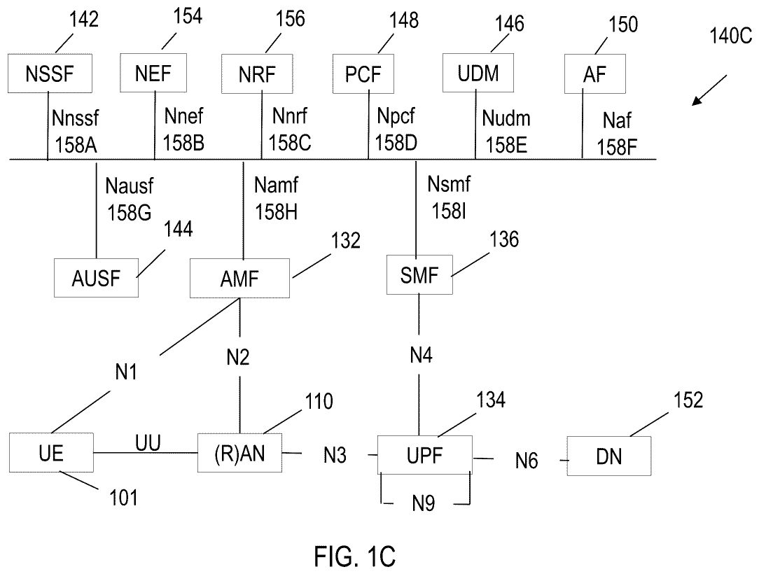

FIG. 3 illustrates a time-frequency view of a CSI-RS resource distribution, according to some examples. The diagram illustrates CSI-RS resources distributed across multiple slots, where slot 1 and slot 2 represent different transmission time intervals. Each slot contains multiple Physical Resource Blocks (PRBs) numbered from 0 to 13, with CSI-RS resources mapped across the PRBs. The CSI-RS resources are arranged in a grid structure where the horizontal axis represents PR B indices (0-13) and the vertical axis represents different CSI-RS resources (1-4). This arrangement enables the system to distribute CSI-RS transmissions across frequency and time domains.

As shown in FIG. 3, the system includes valid CSI-RS resources 302 and 304, which represent transmitted or available resources belonging to subset A₁. The resources may be used for channel measurement and CSI feedback calculation. The diagram also shows cancelled or dropped CSI-RS resources 312 and 314, which belong to subset A₂. These resources may become unavailable due to collisions with other signals, measurement gaps, or semi-statically configured uplink symbols in TDD operation.

The system processes CSI-RS resources through joint UE processing mechanisms that support up to 128 CSI-RS ports by utilizing multiple CSI-RS resources, with each resource supporting up to 32 CSI-RS ports. The resource allocation system interfaces with TDD configuration parameters, where CSI-RS transmission scheduling must account for UL/DL switching patterns, potential collisions with other signals such as SSBs, and measurement gaps.

In some examples, when subset A₁ of valid CSI-RS resources is received, the system may calculate CSI with zero channel power for CSI-RS ports corresponding to the cancelled resources in subset A₂. Alternatively, the system may calculate CSI using only the available CSI-RS ports from subset A₁, adapting the PMI codebook accordingly.

### CSI Reporting for Subset of CSI-RS Resources

In one embodiment, for a CSI-ReportConfig configured with a PMI codebook for up to 128 CSI-RS ports, after the CSI report (re) configuration, serving cell activation, bandwidth part (BWP) change, or activation of Semi-Persistent CSI (SP-CSI), the UE transmits a CSI report only after receiving at least one CSI-RS transmission occasion for each of the CSI-RS resources in the corresponding CSI-RS Resource Set for channel measurement no later than the CSI reference resource and within the same Discontinuous Reception (DRX) Active Time, when DRX is configured, and drops the report otherwise.

If the subset of CSI-RS resources is cancelled or dropped due to collision with other reference signals or semi-statically configured UL symbols (for TDD symbols), another CSI-RS resource that is not cancelled may continue to be used for the CSI report.

In this case, for example, for a CSI-ReportConfig configured with a PMI codebook of up to 128 CSI-RS ports, in response to the UE receiving a subset of the valid CSI-RS resources A₁ in the corresponding CSI-RS Resource Set for channel measurement, the UE calculates a CSI with zero channel power for CSI-RS ports corresponding to the subset of cancelled or dropped CSI-RS resources A₂. In this case, the UE uses the PMI codebook corresponding to the number of ports in set of CSI-RS resources configured for the channel measurements A for the CSI-ReportConfig.

Alternatively, for a CSI-ReportConfig configured with a PMI codebook for up to 128 CSI-RS ports, in response to the UE receiving a subset of the valid CSI-RS resources A₁ in the corresponding CSI-RS Resource Set for channel measurement, the UE calculates CSI for CSI-RS ports corresponding to subset of CSI-RS resources A₁. In this case, for the CSI-ReportConfig, the UE uses the PMI codebook corresponding to the number of ports in subset A₁.

Further, for a CSI-ReportConfig configured with a PMI codebook for up to 128 CSI-RS ports, in response to timeRestrictionForChannel Measurements not being configured, and the UE receives a subset of the valid CSI-RS resources A₁ in the corresponding CSI-RS Resource Set for channel measurement, the UE uses CSI-RS resources in subset A₁ for channel averaging. In this case, the CSI-RS resources that are cancelled or dropped, (i.e., subset A₂) are not used for channel averaging.

In another embodiment, the UE may not expect that a subset of CSI-RS resources is cancelled or dropped for a CSI-ReportConfig configured with a PMI codebook for up to 128 CSI-RS ports.

The UE capability on the solution for CSI reporting with the subset of CSI-RS resources can be considered to allow different UE implementations.

Further, the UE may report UE capability for CSI reporting with the subset of CSI-RS resources, considering the above embodiments.

In one embodiment, the second CSI-RS resource for resource aggregation for up to 128 ports is transmitted in a next available slot, whether the available slot for CSI-RS resource transmission is determined as the slot and whether CSI-RS resource does not overlap semi-statically configured UL symbols in the TDD system or SSB symbols. In this case, the first slot for the first CSI-RS resource for resource aggregation for up to 128 ports may be determined in accordance with the existing 3GPP specification, while the second slot for the second CSI-RS resource for resource aggregation for up to 128 ports is determined in accordance with the next available slot.

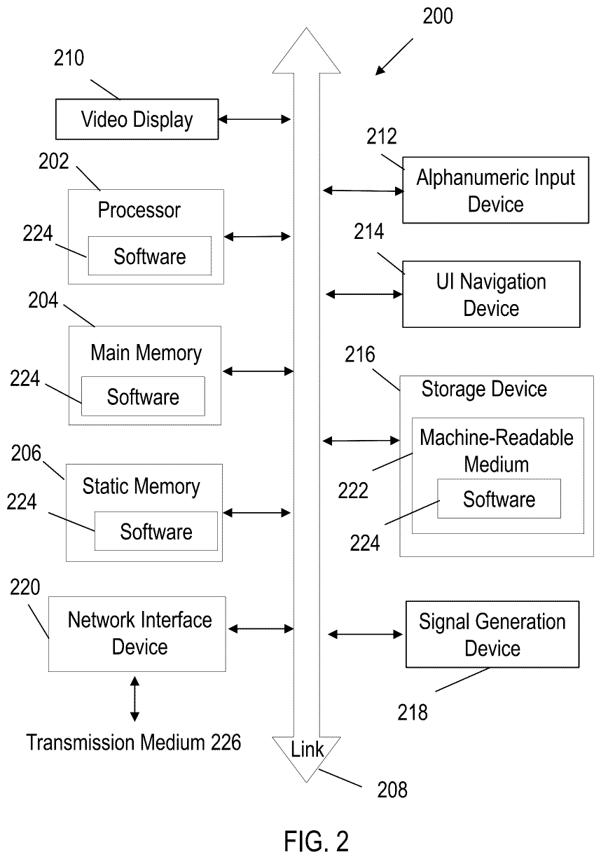

FIG. 4 illustrates a transmission of second CSI-RS resource for resource aggregation for up to 128 ports in an available slot, according to some examples. In FIG. 4, the first slot for the first CSI-RS resource 402 for resource aggregation for up to 128 ports may be determined in accordance with the existing 3GPP specification, while the second slot for the second CSI-RS resource 404 for resource aggregation for up to 128 ports is determined in accordance with the next available slot. Note that the second and third slots are semi-statically configured as uplink slots in the TDD system, and are determined as non-available slots for transmission of the CSI-RS.

Thus, the system implements a scheduling mechanism in which the first CSI-RS resource 402 follows baseline transmission specifications, while the second CSI-RS resource 404 employs adaptive scheduling to utilize the next available slot that avoids overlap with semi-statically configured uplink slots. The system supports multiple CSI-RS transmission modes including periodic, semi-persistent, and aperiodic configurations. In some examples, the scheduling system may coordinate both first and second CSI-RS resources for resource aggregation to transmit in the next available slots, where the availability is determined by analyzing potential overlaps with semi-statically configured UL symbols in TDD systems or SSB symbols.

In some aspects, transmission of the second CSI-RS resource for a resource aggregation for up to 128 ports in a next available slot may apply for periodic, semi-persistent and/or aperiodic CSI-RS resources.

In another embodiment, both the first and second CSI-RS resource for resource aggregation for up to 128 ports are transmitted in the next available slots, where the available slot for CSI-RS resource transmission is determined as the slot whether CSI-RS resource does not overlap semi-statically configured UL symbols in TDD system or SSB symbols.

In some aspects, transmission of the second CSI-RS resource for resource aggregation for up to 128 ports in a next available slot may apply for periodic, semi-persistent and/or aperiodic CSI-RS resources.

Accordingly, joint UE processing of multiple CSI-RS resources is implemented to support up to 128 CSI-RS ports. Each CSI-RS resource supports up to 32 ports, and multiple resources are processed together to accommodate larger antenna configurations. The system enables resource aggregation across different time slots while maintaining compatibility with existing specifications. This interfaces with the CSI feedback components including CRI, RI, PMI, and CQI to provide comprehensive channel state reporting.

In addition, in TDD systems, CSI-RS reception becomes impossible during uplink slots and resources may be unavailable due to collisions with other signals like SSB or measurement gaps. The system enables a variety of approaches, including a) zero-power calculation in which the UE calculates the CSI assuming zero channel power for unavailable CSI-RS ports while maintaining the original PMI codebook corresponding to the total configured ports, b) adaptive PMI calculation in which the UE processes only available CSI-RS ports using a PMI codebook matched to the number of valid ports, and/or c) channel averaging in which only valid CSI-RS resources are used when timing restrictions are not configured.

An adaptive scheduling mechanism is used when CSI-RS resources conflict with semi-statically configured UL symbols or other reference signals. In this case, CSI-RS resource transmission may be scheduled in the next available slot that avoids overlap with UL symbols or SSB. The scheduling system supports periodic, semi-persistent, and aperiodic CSI-RS resources. Both CSI-RS resources can be scheduled in next available slots to avoid conflicts with semi-statically configured UL symbols or SSB symbols.

As different UE implementations have varying capabilities for processing partial CSI-RS resources capability reporting may be used. In this case, the UE reports supported methods for CSI reporting with subset of CSI-RS resources. The system then configures UE behavior based on the reported capabilities.

CSI reporting is further coordinated with various system events and timing requirements while maintaining measurement accuracy. To this end, a coordinated reporting mechanism may be used in which CSI reporting initiates after specific triggering events (report reconfiguration, cell activation, BWP change). Reports are generated only after receiving at least one CSI-RS transmission for each configured resource, with the reporting timing aligning with CSI reference resource timeframe and active reception periods. The system supports channel averaging operations when timing restrictions are not configured.

In addition to supporting CSI reporting using a subset of CSI-RS resources from the set of CSI-RS resources configured for joint CSI processing, adaptive CSI reporting may be provided as indicated above. In particular, the accuracy and timeliness of CSI feedback face inherent challenges due to channel dynamics and measurement limitations. Channel conditions can vary significantly based on factors like user mobility, signal propagation environment, and interference patterns. Additionally, the process of measuring, processing and reporting CSI introduces unavoidable delays between when measurements are taken and when the information can be applied for transmission. CSI compression using precoding matrix codebooks allows for efficient feedback but introduces tradeoffs between feedback overhead and channel representation accuracy. The effectiveness of CSI feedback also depends on proper configuration of measurement and reporting parameters to match the actual channel conditions being experienced.

The adaptive CSI reporting techniques may improve downlink transmissions in cellular systems by introducing CSI performance metrics that enable adaptive reporting mechanisms. The metrics can be calculated at the UE to evaluate various aspects of CSI quality, including compression loss, aging effects, and prediction accuracy. The metrics utilize mathematical functions such as mean square error, normalized mean square error, and generalized cosine similarity to quantify CSI performance.

Several adaptive mechanisms may be used. In one approach, UEs can select different PMI codebooks based on calculated performance metrics. For instance, a UE may choose between Type I or Enhanced Type II PMI codebooks depending on the measured compression loss. The selection of codebook parameters can also be adapted, such as adjusting the number of time instances considered in the Enhanced Type II PMI codebook based on prediction performance.

Another adaptation mechanism involves CSI prediction. In this case, UEs can decide whether to apply prediction to CSI reports based on channel conditions and prediction performance metrics. This decision can be conveyed to the network through indicator bits in the CSI report. Similarly, UEs can adapt their CSI averaging behaviour and indicate the choices in the corresponding reports.

In reporting CSI performance metrics to the network, UEs can transmit various quality indicators including compression loss, aging loss, averaging loss, and prediction loss. The metrics help the network understand the reliability of reported CSI and can guide configuration decisions. Additionally, UEs can report simplified monitoring outputs, such as the results of comparing performance metrics against configured thresholds.

The network can configure different reporting behaviours based on observed channel conditions. For example, different PMI codebooks might be specified for different UE velocity ranges. The configuration can also consider other channel parameters such as line-of-sight conditions or special deployment scenarios like airborne or indoor operation.

UEs autonomously select appropriate reporting configurations based on local measurements and calculations. The network maintains control through higher-layer configuration of allowable options and thresholds. This combination enables CSI reporting to adjust to varying channel conditions while maintaining network oversight.

The performance metrics and adaptation mechanisms operate across multiple time scales. Some metrics evaluate instantaneous CSI quality, while others assess longer-term effects like channel aging or prediction accuracy. This multi-timescale approach allows the system to address both rapid channel variations and slower changes in propagation conditions.

In particular, the PMI corresponds to precoding matrix W_{ϵ}C that is determined to be optimal for PDSCH transmission at the UE, where C is the PMI codebook configured for CSI reporting at the UE. In the hypothetical scenario of an infinite number of bits for PMI reporting, the precoding matrix V_{ϵ}M (P, RI, N₃) is determined to be optimal for the PDSCH transmission at the UE, where M (P, RI, N₃) is the set of all complex-valued P×RI matrixes for N3 subcarriers or resource elements (RE) or subbands, and P is the number of CSI-RS ports. For example, V may correspond to RI right singular value decomposition (SVD) vectors of the channel matrix or channel covariance matrix measured at the UE. W can be referred to as a compressed precoding matrix, while V can be referred to as a non-compressed precoding matrix.

A UE may be configured to report CSI corresponding to one channel measurement instance (i.e., when timeRestrictionForChannelMeasurements is configured). In this case, compressed and non-compressed precoding matrixes are denoted as Wᵢₙₛₜ(n) and Vᵢₙₛₜ(n) respectively, where n corresponds to time instance index (e.g., slot index) corresponding to the channel measurements.

In addition, or instead, a UE may be configured to report CSI corresponding to averaged channel measurements over multiple instances (i.e., timeRestrictionForChannelMeasurements is not configured). In this case, the compressed and non-compressed precoding matrixes are denoted as W_{avg} and V_{avg} respectively.

In addition, or instead, a UE may be configured to report CSI corresponding to one or more future time instance(s). Such a configuration may involve CSI prediction at the UE using channel measurements on multiple CSI-RS instances. In this case, the compressed and non-compressed precoding matrixes are denoted as W_{pred}(n) and V_{pred}(n) respectively, where n corresponds to time instance index (e.g., slot index) corresponding to the CSI prediction.

Precoding matrices corresponding to N₄>1 time instance can be jointly compressed and transmitted in the CSI report. In this case, for a fixed number of bits, the accuracy of channel information representation with PMI can be expected to decrease with larger N₄.

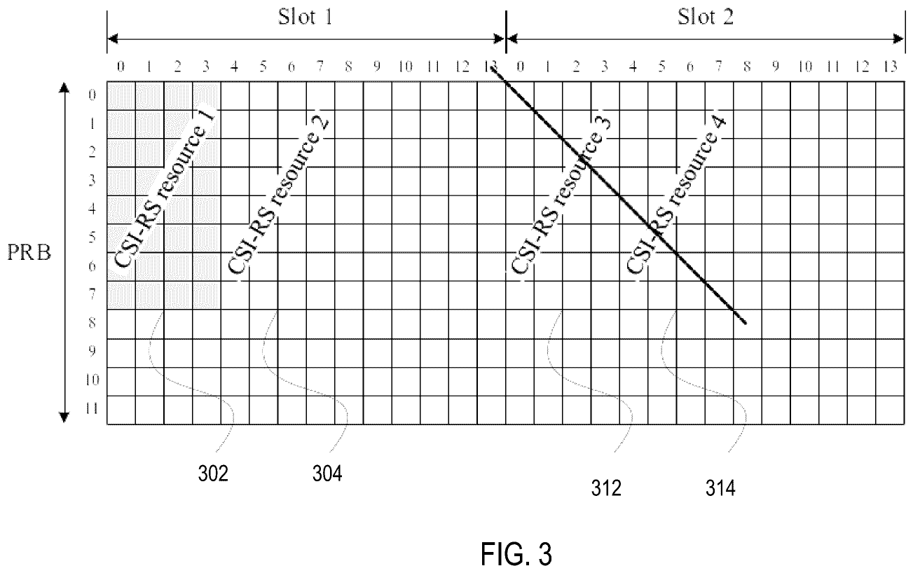

FIG. 5 is a schematic diagram showing a functional view of a CSI reporting configuration selection system, according to some examples. FIG. 5 illustrates a configuration selection mechanism based on a channel condition parameter p, in particular depicting a binary configuration selection mechanism in which one of two distinct CSI reporting configurations is selected based on a threshold value Po. When the channel condition parameter p is below Po, the system utilizes CSI configuration 1. Conversely, when p exceeds Po, the system switches to CSI configuration 2.

The channel condition parameter p may represent various measurable characteristics, including UE velocity, line-of-sight (LOS) vs non-line-of-sight (NLOS) channel conditions, and/or CSI performance metrics (e.g., aging loss, compression loss, prediction loss). For example, UE velocity thresholds such as 30 km/h for Type I vs Type II PMI codebook selection may be used. Other channel condition parameters may include airborne vs ground-based UE operation modes and/or indoor vs outdoor deployment scenarios.

The threshold Po may be configured by the network or defined within system specifications. The threshold Po may be configured via higher layer signaling from the gNB. The threshold Po may be based on CSI quality metrics rather than physical parameters and may be set differently for various CSI configuration aspects.

The system supports multiple configuration adaptation mechanisms including PMI codebook selection (Type I vs Enhanced Type II), PMI codebook parameter adjustment (e.g., N4 value selection), CSI prediction horizon modification (e.g., 10 ms vs 20 ms based on UE speed), CSI averaging behavior adaptation, and/or number of reported precoding matrices.

In some examples, the system may implement multiple thresholds to support more granular configuration selection. For instance, different prediction horizons may be configured based on UE speed ranges such as: below 10 km/h: 20 ms prediction distance; above 10 km/h: 10 ms prediction distance. The thresholds may be dynamically adjusted based on CSI performance metrics feedback.

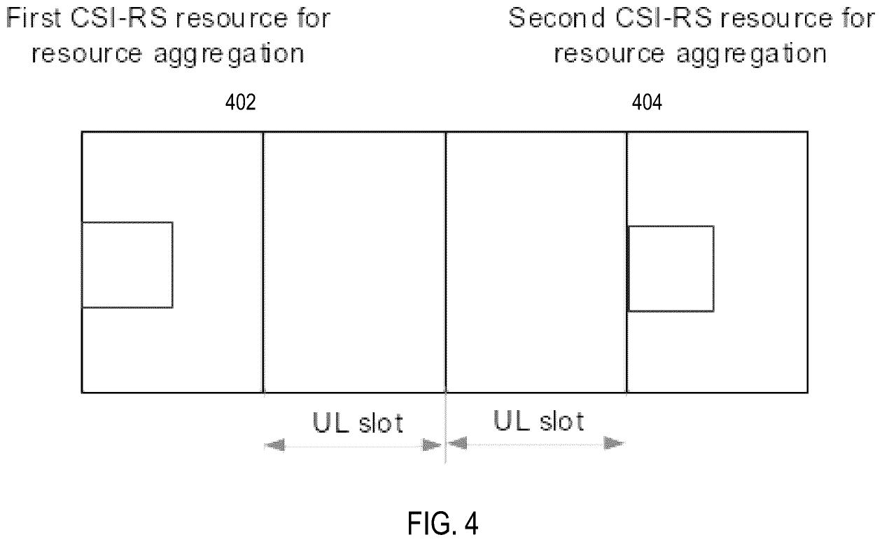

FIG. 6 illustrates a block diagram showing a CSI performance metrics calculation process at the UE, according to some examples. FIG. 6 depicts the data flow and processing components for generating CSI performance metrics from input measurements and configuration parameters and includes three main components: CSI measurements input, CSI configuration input, and a processor. The processor combines the inputs to generate CSI performance metrics as output. The CSI measurements input receives channel measurements from CSI-RS and CSI Interference Measurements (CSI-IM). The CSI configuration input receives configuration parameters from the network.

The processor implements multiple calculation functions including: compression loss metrics: g(W,V) for instantaneous CSI M inst(n), averaged CSI M avg, and predicted CSI M pred(n); aging loss metrics: Lw(n,ndelay), Lv(n,ndelay), and Lwv(n,ndelay); averaging loss metrics: Qw(n), Qv(n), and Qwv(n); and/or prediction loss metrics: Rw(n), Rv(n), and Rwv(n).

The system supports various mathematical functions for metric calculation. The mathematical functions include one or more of: mean square error (MSE), normalized mean square error (NMSE), generalized cosine similarity (GCS), and square generalized cosine similarity (SGCS).

The output CSI performance metrics may be calculated in a variety of manners. For example, the CSI performance metrics may be calculated one or more of: per subband, spatial-domain basis vector, or delay (frequency domain basis vector), or averaged over layers for RI>1 or over the frequency or time domain.

Examples of NMSE, GCS, SGCS correspond to equation (1), (2), (3) respectively for vectors V₁ and V₂ (columns of precoding matrix). For RI>1, averaging of the CSI performance metrics over layers can be considered or, V₁ and V₂ can correspond to precoding matrixes with RI columns (layers). A veraging of CSI performance metrics in frequency domain (e.g., over subcarriers, subbands) and in time domain (e.g., over symbols, slots) can be considered.

$$g ( {V}_{1} , {V}_{2} ) = {‖ {V}_{1} - {V}_{2} ‖}^{2} / {‖ {V}_{2} ‖}^{2} \qquad ( 1 )$$

$$g ( {V}_{1} , {V}_{2} ) = ‖ {V}_{1} \cdot {V}_{2}^{H} ‖ / \{ ‖ {V}_{1} ‖ \cdot ‖ {V}_{2} ‖ \} \qquad ( 2 )$$

$$g ( {V}_{1} , {V}_{2} ) = {[ ‖ {V}_{1} \cdot {V}_{2}^{H} ‖ / \{ ‖ {V}_{1} ‖ \cdot ‖ {V}_{2} ‖ \} ]}^{2} \qquad ( 3 )$$

In other option, CSI performance metrics corresponds to CQI, channel capacity, and/or signal-to-noise ratio (SINR), or difference in the CQI, channel capacity, and/or SINR for cases where V₁ and V₂ are applied as the precoder for a hypothetical PDSCH transmission. As above, the CSI performance metrics can be calculated per each subband, per each spatial-domain basis vector, and/or per each delay (frequency domain basis vector).

In one embodiment, the UE may calculate CSI performance metrics M=g(W,V) referred as compression loss. Compression loss can be calculated for instantaneous CSI Mᵢₙₛₜ(n)=g(Wᵢₙₛₜ(n), Vᵢₙₛₜ(n), CSI with averaging M_{avg}=g(W_{avg}, V_{avg}) and CSI with prediction M_{pred}(n)=g(W_{pred}(n), V_{pred}(n)).

Alternatively, or in addition, the UE may calculate CSI performance metrics referred to as aging loss L_{W}(n,n_{delay})=g(Wᵢₙₛₜ(n), Wᵢₙₛₜ(n−n_{delay})), L_{V}(n,n_{delay})=g(Vᵢₙₛₜ(n), Vᵢₙₛₜ(n−n_{delay}), or L_{wv}(n,n_{delay})=g(Vᵢₙₛₜ(n), Wᵢₙₛₜ(n−n_{delay}), where n_{delay} corresponds to the CSI-RS periodicity or may be configured by higher layers.

Alternatively, or in addition, the UE may calculate CSI performance metrics referred to as averaging loss Q_{W}(n)=g(W_{avg}, Wᵢₙₛₜ(n)), Q_{V}(n)=g(V_{avg}, Vᵢₙₛₜ(n)) or Q_{WV}(n)=g(W_{avg},Vᵢₙₛₜ(n)). Here V_{avg} and W_{avg} may or may not include channel measurements in time instance n.

Alternatively, or in addition, the UE may calculate CSI performance metrics referred to as prediction loss R_{W}(n)=g(Wᵢₙₛₜ(n), W_{pred}(n)), R_{V}(n)=g(Vᵢₙₛₜ(n), V_{pred}(n)), or R_{WV}(n)=g(Vᵢₙₛₜ(n), W_{pred}(n)). Further, prediction loss can be calculated relative to aging loss or averaging loss as follows: R_{W}/L_{W} or R_{V}/L_{V} or R_{WV}/L_{WV} or R_{W}/Q_{W} or R_{V}/Q_{V} or R_{WV}/Q_{WV}.

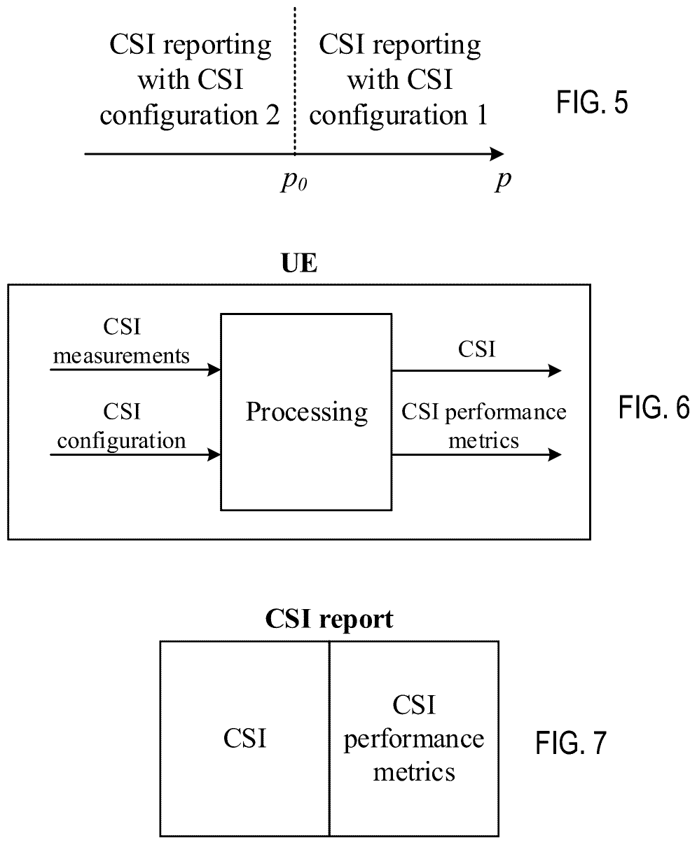

FIG. 7 illustrates a block diagram illustrating the structure of a CSI report that includes both CSI data and CSI performance metrics, according to some examples. FIG. 7 shows how the two components are integrated into a single report structure for transmission to the network. In particular, as shown, the CSI report structure contains traditional CSI components (CQI, RI, PMI), CSI performance metrics or comparison results, configuration selection indicators, and/or prediction and averaging status indicators.

Given that some aspects related to CSI (DL channel properties, UE antenna array design, PMI search implementation, etc.) may not be known at the gNB side, UE can make a decision on the actual CSI content based on information available at the UE side.

More specifically, a UE may select a PMI codebook for a CSI report, with a PMI codebook indicator transmission in the CSI report. In one example, the UE may select Type I or Enhanced Type II PMI codebook depending on the CSI compression loss corresponding to different codebooks. In another example, the UE may select the Enhanced Type II PMI codebook or Enhanced Type II PMI codebook for a predicted PMI based on the CSI prediction loss. The set of PMI codebooks for UE selection can be configured via higher layers.

For a given PMI codebook, the UE may select different values for a PMI codebook parameter, with the PMI codebook parameter transmission in the CSI report. For example, the UE may select different values of parameter N₄ for the Enhanced Type II PMI codebook for a predicted PMI based on the CSI prediction loss and/or CSI compression loss corresponding to different time instances. The set of PMI codebook parameters for UE selection can be configured via higher layers.

Alternatively, or in addition, a gNB may configure a UE to use different PMI codebooks for a CSI report depending on the channel parameter range observed at the UE. This means that the CSI feedback is configured in a different manner dependent on the channel condition parameter observed (e.g., as above UE movement speed, NLOS/LOS channel, airborne UE, indoor UE, or any other special channel condition) at the UE. For example, the gNB may configure the UE to use the Type I PMI codebook if the UE travels at higher speed than 30 km/h, but Type II PMI codebook is used if the UE travels at a speed lower than the 30 km/h. Alternatively, the threshold may be defined based on the values of one or more CSI quality metrics, e.g., aging loss (defined above), instead of thresholding of a physical metric such as UE speed that may not always be directly observable.

Given that some aspects related to CSI (DL channel properties, CSI prediction implementation, CSI averaging implementation) may not be known at the gNB, the UE can make a decision on the actual CSI content based on information available at the UE.

A UE may report the CSI with CSI prediction or without CSI prediction, where at least one bit of information is transmitted from the UE in the CSI report to indicate whether or not CSI prediction was performed. In addition, the decision can be made per time instance if N₄>1 precoding matrixes corresponding to different time instances are reported.

Further, a UE may report the CSI with CSI averaging or without averaging, where at least one bit of information is transmitted from the UE in the CSI report to indicate whether or not CSI averaging was performed. In addition, the decision can be made per time instance if N₄>1 precoding matrixes corresponding to different time instances are reported.

In another embodiment, the network configures the UE to use different a PMI prediction horizon for a CSI report depending on the channel parameter range observed at the UE. This means that the PMI prediction is configured in a different manner dependent on the channel condition parameter observed (UE movement speed, NLOS/LOS channel, airborne UE, indoor UE, or any other special channel condition) at the UE. This could, for example, operate in the following manner in a scenario with 5 ms CSI-RS periodicity but 20 ms CSI reporting periodicity, the network configures the UE to report the predicted PMI every 20 ms if the UE speed is below 10 km/h. If the UE moves at a higher speed than 10 km/h, 10 ms may be used as the prediction distance for the predicted PMI.

Alternatively, or in addition, to configuring thresholds on one or more physical attributes (e.g., UE speed, airborne state, LOS/NLOS likelihood), one or more threshold(s) may be configured to a UE by a serving gNB for one or more CSI (or PMI) performance/quality metrics defined above. Accordingly, the UE may perform switching between prediction models, including fallback behavior, autonomously based on comparison of the calculated CSI performance/quality metric(s) against the configured threshold(s).

To facilitate decision on the CSI configuration at the gNB side, or, to justify and/or indicate decision done by the UE, CSI performance metrics can be transmitted with a CSI report. In one embodiment, a UE may report CSI compression loss, CSI aging loss, CSI averaging loss, and/or CSI prediction loss. Further, a UE may report CSI aging loss for different values n_{delay}. Further, the content of the reported CSI (e.g., PMI codebook, PMI codebook parameter, CSI prediction on/off, and/or CSI averaging on/off) may depend on the reported value(s) for CSI performance metrics.

Information on the exact CSI performance metrics might not be desired at the network side. Instead, the UE may report output of performance monitoring procedure configured at the UE.

In one embodiment, the UE reports the result of a comparison of CSI performance metrics and a threshold, where the threshold is configured by the gNB or fixed in the specification. Also, the comparison can be made per time instance if N₄>1 precoding matrixes corresponding to different time instances are reported.

In other embodiment, the UE reports the result of a comparison for different CSI performance metrics (e.g., prediction loss and averaging loss, or, averaging loss and aging loss, or compression loss for PMI codebook A and compression loss for PMI codebook B). The comparison can be made per time instance if N₄>1 precoding matrixes corresponding to different time instances are reported.

Further, the content of the reported CSI (e.g., PMI codebook, PMI codebook parameter, CSI prediction on/off, CSI averaging on/off) may depend on the result of comparison of CSI performance metrics and a threshold or result of a comparison for different CSI performance metrics.

### EXAMPLES

Example 1 is an apparatus for a user equipment (UE), the apparatus comprising a processor, the processor to configure the UE to: configure channel state information (CSI) reporting and CSI measurements on CSI Reference Signal (CSI-RS) resources from a set of CSI-RS resources; measure CSI-RS on the CSI-RS resources from a first subset of CSI-RS resources contained in the set of CSI-RS resources; and calculate and report, in a CSI report, CSI based on measured CSI-RS using the CSI-RS ports, wherein CSI-RS ports across the set of CSI-RS resources are used jointly for Rank Indicator (RI), Precoding Matrix Indicator (PMI), and Channel Quality Indicator (PMI), and wherein the UE comprises more than 32 CSI-RS virtual antenna ports, each virtual CSI-RS antenna port corresponding to a specific resource element within a resource block.

In Example 2, the subject matter of Example 1 includes, wherein a second subset of CSI-RS resources contained in the set of CSI-RS resources cancelled or dropped due to collision with other reference signals, semi-statically configured uplink symbols, or a measurement gap.

In Example 3, the subject matter of Example 2 includes, wherein the processor is further configured to: determine whether the second subset of CSI-RS resources is empty; and not transmit the CSI report if the second subset of CSI-RS resources is not empty.

In Example 4, the subject matter of Examples 2-3 includes, wherein one of: the processor is further configured to calculate the RI, PMI and CQI with zero channel power assumed for CSI-RS ports corresponding to the second subset of CSI-RS resources, and the PMI corresponds to a number of CSI-RS ports in the set of CSI-RS resources, or the processor is further configured to calculate the RI, PMI and CQI for CSI-RS ports corresponding to the first subset of CSI-RS resources, and the PMI corresponds to a number of CSI-RS ports in the first subset of CSI-RS resources.

In Example 5, the subject matter of Examples 2-4 includes, wherein the processor is further configured to: use CSI-RS ports corresponding to the first subset of CSI-RS resources for channel averaging; and calculate the RI, PMI and CQI based on averaged channel measurements corresponding to CSI-RS ports corresponding to the set of CSI-RS resources.

In Example 6, the subject matter of Examples 1-5 includes, wherein the processor is further configured to: determine whether configured CSI-RS resource reception collides with at least one other reference signals, semi-statically configured uplink symbols, or a measurement gap; and in response to a determination that a collision is to occur, delay CSI-RS reception to a next available slot, where CSI-RS resources in available slot do not collide with the at least one other reference signals, semi-statically configured uplink symbols, or measurement gap.

In Example 7, the subject matter of Example 6 includes, wherein the processor is further configured to delay all configured CSI-RS resources such that the set of CSI-RS resources does not collide with the at least one other reference signals, semi-statically configured uplink symbols, or measurement gap.

Example 8 is an apparatus for a user equipment (UE), the apparatus comprising a memory configured to store channel state information (CSI) and a processor, the processor to configure the UE to: measure the CSI using CSI Reference Signals (CSI-RS) and CSI Interference Measurements (CSI-IM); calculate CSI performance metrics based on CSI measurements; determine a CSI configuration based on the CSI performance metrics; and report the CSI and the CSI performance metrics based on the CSI configuration.

In Example 9, the subject matter of Example 8 includes, wherein to calculate the CSI performance metrics, the processor is configured to at least one of: calculate a first precoding matrix based on the CSI-RS and a configured Precoding Matrix Indicator (PMI) codebook, or calculate a second precoding matrix based on the CSI-RS, where the second precoding matrix is a member of a set of complex-valued matrices.

In Example 10, the subject matter of Example 9 includes, wherein the processor is configured to calculate at least one of the first precoding matrix or the second precoding matrix based on at least one of: CSI-RS measured or predicted in a single time instance, or channel measurements averaged over multiple CSI-RS time instances.

In Example 11, the subject matter of Examples 8-10 includes, wherein at least one of: the CSI performance metrics comprise at least one of: compression loss metrics, aging loss metrics, averaging loss metrics, or prediction loss metrics, or the processor is configured to calculate the CSI performance metrics using at least one of: normalized mean square error (NM SE), generalized cosine similarity (GCS), or square generalized cosine similarity (SGCS).

In Example 12, the subject matter of Examples 8-11 includes, wherein: a set of CSI configurations is configured to the UE, the set of CSI configurations correspond to different PMI codebooks or different PMI codebook parameters, and to determine the CSI configuration, the processor is configured to select between the different PMI codebooks or different PMI codebook parameters based on the CSI performance metrics.

In Example 13, the subject matter of Examples 8-12 includes, wherein: a set of CSI configurations is configured to the UE, the set of CSI configurations correspond to CSI with prediction, CSI without prediction, CSI with averaging, and CSI without averaging, and to determine the CSI configuration, the processor is configured to select between the set of CSI configurations based on the CSI performance metrics.

In Example 14, the subject matter of Examples 8-13 includes, wherein: a set of CSI configurations is configured to the UE, the set of CSI configurations correspond to different PMIs for different time instances, and to determine the CSI configuration, the processor is configured to select between the set of CSI configurations based on the CSI performance metrics.

In Example 15, the subject matter of Examples 8-14 includes, wherein the processor is configured to: compare the CSI performance metrics and a threshold; and at least one of: report a comparison between the CSI performance metrics and the threshold with the CSI and the CSI performance metrics, or determine the CSI configuration based on the comparison.

In Example 16, the subject matter of Examples 8-15 includes, wherein the processor is configured to: compare the CSI performance metrics determined different times; and at least one of: report a comparison between the CSI performance metrics determined different times, or determine the CSI configuration based on the comparison.

In Example 17, the subject matter of Examples 8-16 includes, th generation NodeB (gNB), another CSI configuration based on a comparison at least one of: between the CSI performance metrics and a threshold or between CSI performance metrics determined different times in response to transmission of the comparison to the gNB.

Example 18 is a non-transitory computer-readable storage medium that stores instructions for execution by one or more processors of a user equipment (UE), the instructions, when executed, cause the UE to: configure channel state information (CSI) reporting and CSI measurements on CSI Reference Signal (CSI-RS) resources from a set of CSI-RS resources; measure CSI-RS on the CSI-RS resources from a first subset of CSI-RS resources contained in the set of CSI-RS resources; and calculate and report, in a CSI report, CSI based on measured CSI-RS using the CSI-RS ports, wherein CSI-RS ports across the set of CSI-RS resources are used jointly for Rank Indicator (RI), Precoding Matrix Indicator (PMI), and Channel Quality Indicator (PMI), and wherein the UE comprises more than 32 CSI-RS virtual antenna ports, each virtual CSI-RS antenna port corresponding to a specific resource element within a resource block.

In Example 19, the subject matter of Example 18 includes, wherein a second subset of CSI-RS resources contained in the set of CSI-RS resources cancelled or dropped due to collision with other reference signals, semi-statically configured uplink symbols, or a measurement gap.

In Example 20, the subject matter of Example 19 includes, wherein executed, cause the UE to: determine whether the second subset of CSI-RS resources is empty; and not transmit the CSI report if the second subset of CSI-RS resources is not empty.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a user equipment (UE), the apparatus comprising a processor, the processor to configure the UE to:
configure channel state information (CSI) reporting and CSI measurements on CSI Reference Signal (CSI-RS) resources from a set of CSI-RS resources;
measure CSI-RS on the CSI-RS resources from a first subset of CSI-RS resources contained in the set of CSI-RS resources; and
calculate and report, in a CSI report, CSI based on measured CSI-RS using the CSI-RS ports,
wherein CSI-RS ports across the set of CSI-RS resources are used jointly for Rank Indicator (RI), Precoding Matrix Indicator (PMI), and Channel Quality Indicator (PMI), and
wherein the UE comprises more than 32 CSI-RS virtual antenna ports, each virtual CSI-RS antenna port corresponding to a specific resource element within a resource block.

2. The apparatus of claim 1, wherein a second subset of CSI-RS resources contained in the set of CSI-RS resources cancelled or dropped due to collision with other reference signals, semi-statically configured uplink symbols, or a measurement gap.

3. The apparatus of claim 2, wherein the processor is further configured to:
determine whether the second subset of CSI-RS resources is empty; and
not transmit the CSI report if the second subset of CSI-RS resources is not empty.

4. The apparatus of claim 2, wherein one of:
the processor is further configured to calculate the RI, PMI and CQI with zero channel power assumed for CSI-RS ports corresponding to the second subset of CSI-RS resources, and the PMI corresponds to a number of CSI-RS ports in the set of CSI-RS resources, or
the processor is further configured to calculate the RI, PMI and CQI for CSI-RS ports corresponding to the first subset of CSI-RS resources, and the PMI corresponds to a number of CSI-RS ports in the first subset of CSI-RS resources.

5. The apparatus of claim 2, wherein the processor is further configured to:
use CSI-RS ports corresponding to the first subset of CSI-RS resources for channel averaging; and
calculate the RI, PMI and CQI based on averaged channel measurements corresponding to CSI-RS ports corresponding to the set of CSI-RS resources.

6. The apparatus of claim 1, wherein the processor is further configured to:
determine whether configured CSI-RS resource reception collides with at least one other reference signals, semi-statically configured uplink symbols, or a measurement gap; and
in response to a determination that a collision is to occur, delay CSI-RS reception to a next available slot, where CSI-RS resources in available slot do not collide with the at least one other reference signals, semi-statically configured uplink symbols, or measurement gap.

7. The apparatus of claim 6, wherein the processor is further configured to delay all configured CSI-RS resources such that the set of CSI-RS resources does not collide with the at least one other reference signals, semi-statically configured uplink symbols, or measurement gap.

8. An apparatus for a user equipment (UE), the apparatus comprising a memory configured to store channel state information (CSI) and a processor, the processor to configure the UE to:
measure the CSI using CSI Reference Signals (CSI-RS) and CSI Interference Measurements (CSI-IM);
calculate CSI performance metrics based on CSI measurements;
determine a CSI configuration based on the CSI performance metrics; and
report the CSI and the CSI performance metrics based on the CSI configuration.

9. The apparatus of claim 8, wherein to calculate the CSI performance metrics, the processor is configured to at least one of:
calculate a first precoding matrix based on the CSI-RS and a configured Precoding Matrix Indicator (PMI) codebook, or
calculate a second precoding matrix based on the CSI-RS, where the second precoding matrix is a member of a set of complex-valued matrices.

10. The apparatus of claim 9, wherein the processor is configured to calculate at least one of the first precoding matrix or the second precoding matrix based on at least one of:
CSI-RS measured or predicted in a single time instance, or
channel measurements averaged over multiple CSI-RS time instances.

11. The apparatus of claim 8, wherein at least one of:
the CSI performance metrics comprise at least one of: compression loss metrics, aging loss metrics, averaging loss metrics, or prediction loss metrics, or
the processor is configured to calculate the CSI performance metrics using at least one of: normalized mean square error (NMSE), generalized cosine similarity (GCS), or square generalized cosine similarity (SGCS).

12. The apparatus of claim 8, wherein:
a set of CSI configurations is configured to the UE,
the set of CSI configurations correspond to different PMI codebooks or different PMI codebook parameters, and
to determine the CSI configuration, the processor is configured to select between the different PMI codebooks or different PMI codebook parameters based on the CSI performance metrics.

13. The apparatus of claim 8, wherein:
a set of CSI configurations is configured to the UE,
the set of CSI configurations correspond to CSI with prediction, CSI without prediction, CSI with averaging, and CSI without averaging, and
to determine the CSI configuration, the processor is configured to select between the set of CSI configurations based on the CSI performance metrics.

14. The apparatus of claim 8, wherein:
a set of CSI configurations is configured to the UE,
the set of CSI configurations correspond to different PMIs for different time instances, and
to determine the CSI configuration, the processor is configured to select between the set of CSI configurations based on the CSI performance metrics.

15. The apparatus of claim 8, wherein the processor is configured to:
compare the CSI performance metrics and a threshold; and
at least one of:
report a comparison between the CSI performance metrics and the threshold with the CSI and the CSI performance metrics, or
determine the CSI configuration based on the comparison.

16. The apparatus of claim 8, wherein the processor is configured to:
compare the CSI performance metrics determined different times; and
at least one of:
report a comparison between the CSI performance metrics determined different times, or
determine the CSI configuration based on the comparison.

17. The apparatus of claim 8, wherein the processor is configured to receive, from a 5th generation NodeB (gNB), another CSI configuration based on a comparison at least one of: between the CSI performance metrics and a threshold or between CSI performance metrics determined different times in response to transmission of the comparison to the gNB.

18. A non-transitory computer-readable storage medium that stores instructions for execution by one or more processors of a user equipment (UE), the instructions, when executed, cause the UE to:
configure channel state information (CSI) reporting and CSI measurements on CSI Reference Signal (CSI-RS) resources from a set of CSI-RS resources;
measure CSI-RS on the CSI-RS resources from a first subset of CSI-RS resources contained in the set of CSI-RS resources; and
calculate and report, in a CSI report, CSI based on measured CSI-RS using the CSI-RS ports,
wherein CSI-RS ports across the set of CSI-RS resources are used jointly for Rank Indicator (RI), Precoding Matrix Indicator (PMI), and Channel Quality Indicator (PMI), and
wherein the UE comprises more than 32 CSI-RS virtual antenna ports, each virtual CSI-RS antenna port corresponding to a specific resource element within a resource block.

19. The non-transitory computer-readable storage medium of claim 18, wherein a second subset of CSI-RS resources contained in the set of CSI-RS resources cancelled or dropped due to collision with other reference signals, semi-statically configured uplink symbols, or a measurement gap.

20. The non-transitory computer-readable storage medium of claim 19, wherein executed, cause the UE to:
determine whether the second subset of CSI-RS resources is empty; and
not transmit the CSI report if the second subset of CSI-RS resources is not empty.
